(19) United States
(12) Patent Application Publication
(10) Pub. No.: US 2005/0270581 A1
(43) Pub. Date: Dec. 8, 2005

(54) Image processing device and image processing method

(75) Inventors: Hitoshi Yamakado, Hino-shi (JP); Satoshi Yamada, Suwa-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/142,388

(22) Filed: Jun. 2, 2005

(30) Foreign Application Priority Data
Jun. 7, 2004 (JP) 2004-169038
Apr. 7, 2005 (JP) 2005-110764

(51) Int. Cl. G06F 15/00

(52) U.S. Cl. 358/1.18

(57) ABSTRACT

An image processing device that arranges a plurality of images in a specified area, including an image layout portion that arranges a plurality of input images in a specified a an inclusion area calculation portion that calculates an inclusion are that includes all of the input images based on an image positions determined by the image layout portion, and an image layout adjustment portion that adjusts a layout of input images based on the inclusion areas

### BACKGROUND OF THE INVENTION

1. Field of the Invention

The present invention relates to an image processing device, method and program for determining the arrangement of one or a plurality of images in a specified area.

Priority is claimed on Japanese Patent Applications No. 2004-169038, filed Jun. 7, 2004, and No. 2005-110764, filed Apr. 7, 2005, the contents of which are incorporated herein by reference.

2. Description of Related Art

The digitization of photography is proceeding rapidly with the spread of digital cameras and camera-equipped mobile telephones. Because of this, many users, eschewing the time-consuming task of placing conventional photographic prints in paper albums, are instead arranging their digital photos in digital photographic albums and posting them on the Internet, or outputting them with high-quality imaging devices such as color printers. As such, the ways of enjoying digital photographic albums are considered to be increasingly diversified.

Unlike digital photographic albums, paper photographic albums usually entail a person arranging photos by hand until reaching a layout that meets with his or her satisfaction.

For example, Japanese Unexamined Patent Application, First Publication No. H10-293838 discloses an image editing apparatus that adjusts the image overlap amount, image gap amount, image gap amount deviation and image position offset amount to achieve an image layout with good balance. However, the disclosed method repeatedly moves the layout position little by little and evaluates it each time seeking an optimal position, giving rise to the problem of the high cost required for calculation.

Japanese Unexamined Patent Application, First Publication No. H10-340330 discloses an apparatus that finely adjusts the layout of images according to a non-printable area rule, control overlap rule, vertical space allocation rule, horizontal space allocation rule, edge alignment rule, adjacent edge rule and center attraction rule to achieve a balanced arrangement. However, the vertical space allocation rule, horizontal space allocation rule and center attraction rule of the disclosed method, which are related to the present invention, all perform adjustment for individual images, with no consideration given to how an entire group of images is ranged.

### SUMMARY OF THE INVENTION

In light of the aforementioned state of the art, it is an object of the present invention to provide an image processing device and method that can automatically adjust the arrangement of a plurality of images by a simple constitution (process). More specifically, it is an object of the present invention to provide an image processing device and method that can automatically and suitably adjust the placement position of a group of images that are individually arranged by some method or another.

In order to solve the aforementioned problems, the present invention is an image processing device that arranges a plurality of images in a specified area, including an image layout means that arranges a plurality of input images in the specified area, an inclusion area calculation means that calculates an inclusion area that includes all of the input images based on the image positions determined by the image layout means, and an image layout adjustment means that adjusts the layout of images based on the inclusion area. This allows adjustment of the arrangement of the images by calculating the inclusion area, thereby enabling automatic adjustment of the layout of all the images by a simple constitution.

The present invention is characterized by the image layout adjustment means arranging the inclusion area in a center of the specified area. By doing so, the images are automatically arranged around the center of the specified area.

The present invention is characterized by the image layout adjustment means placing the inclusion area so as to touch a boundary of the specified area or be near the boundary of the specified area. By doing so, the images are automatically placed near the boundary of the specified area.

The present invention is an image processing device that arranges a plurality of images in a specified area, including an image layout means that arranging a plurality of input images in the specified area, a centroid calculation means that calculates a centroid of an image group based on an image positions determined by the image layout means, and an image layout adjustment means that adjusts a layout of an image based on the centroid. This enables adjustment of the placement of each image by calculating the center of the image group, thereby enabling automatic adjustment of the layout of all the images by a comparatively simple constitution after considering the degree of distribution.

The present invention is characterized by the image layout adjustment means arranging the centroid in a center of the specified area. By doing so the images are automatically arranged around the center of the specified area.

The present invention is an image processing device that arranges a plurality of images in a specified area, including an image layout means that arranges a plurality of input images in the specified area, an inclusion area calculation means that calculates an inclusion area that includes all of the input images arranged by the image layout means, and an image layout adjustment means that moves each image uniformly based on the positional relation between the specified area and the inclusion area. This enables adjustment of the placement of each image by calculating the inclusion area, thereby enabling automatic adjustment of the layout of the images with a simple constitution.

The present invention is an image processing method that arranges a plurality of images in a specified area, having arranging a plurality of input images in the specified area, calculating an inclusion area that includes all of the input images based on the image positions determined in the arranging of the input images, and adjusting the layout of images based on the inclusion area. The present invention is an image processing method that arranges a plurality of images in a specified area, having arranging a plurality of input images in the specified area, calculating a centroid of a image group based on an image positions determined in the arranging of the input images, and adjusting the layout of an image based on the centroid.

The present invention is an image processing program including instructions which, when executed by a computer, cause arranging a plurality of input images in a specified area, calculating an inclusion area that includes all of the input images based on the image positions determined in the arranging of the input images, and adjusting the layout of images based on the inclusion area. The present invention is an image processing program including instructions which, when executed by a computer, cause arranging a plurality of input images in a specified area, calculating a centroid of a image group based on a image positions determined in the arranging of the input images, and adjusting a layout of an image based on the centroid.

### BRIEF DESCRIPTION OF THE DRAWINGS

FIG. 1 is a diagram showing the constitution of the image processing system including the image processing device of the present invention.

FIG. 2 is a block diagram showing an example constitution for the first embodiment of the image processing device of FIG. 1.

FIG. 3 is a diagram showing the image placement example for explaining the initial layout image data output from the image layout portion of FIG. 2.

FIG. 4 is a diagram showing an example of the layout adjusted output image for explaining the coordinates of adjusted images output from the image adjusting portion of FIG. 2.

FIG. 5 is a flowchart showing the process flow in the first embodiment of the image processing device in FIG. 2.

FIG. 6 is a flowchart showing the process of step S420 in FIG. 5.

FIG. 7 is a diagram showing the coordinate system in the layout area for explaining the process in FIG. 6.

FIG. 8 is a flowchart showing the process flow in the second embodiment (modification) of the image processing device in FIG. 2.

FIG. 9 is a flowchart showing the process of step S700 in FIG. 8.

### DETAILED DESCRIPTION OF THE INVENTION

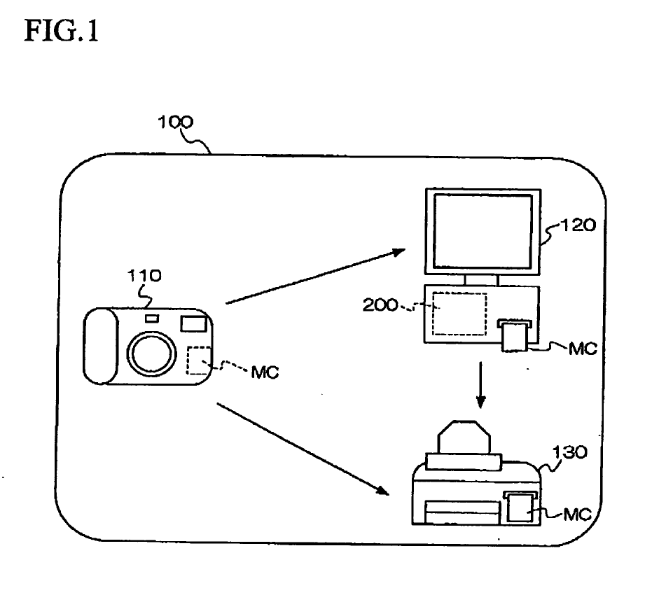

The embodiments of the present invention are explained below referring to the drawings. FIG. 1 is an explanatory diagram showing an image processing system 100 as a first embodiment of the present invention. This image processing system 100 is provided with a digital still camera 110, a personal computer 120 and a color printer 130. An image processing device 200 incorporated in the personal computer 120 is constituted by hardware consisting of a central processing unit and a storage device and the like that make up the personal computer 120 and a program executed by the central processing unit. The image processing device 200 generates an output image based on input images produced by the digital still camera 110, with the graphic data input via a storage medium such as a memory card or a wired or wireless transmission link. While the output image may comprise a single input image, a characteristic of the present embodiment (that is, a function that the image processing device 200 makes the main characteristic) is arranging a plurality of input images in a specified area and generating a single output image. The generated output image then undergoes image quality enhancement by the operation of the image pressing device 200. After such enhancement the output image is output by the color printer 130, which is an output device.

In the present embodiment the image processing device 200 is incorporated in the personal computer 120, but it is possible to incorporate the image processing device 200 in the color printer 130, and it may also be incorporated in the digital still camera 110.

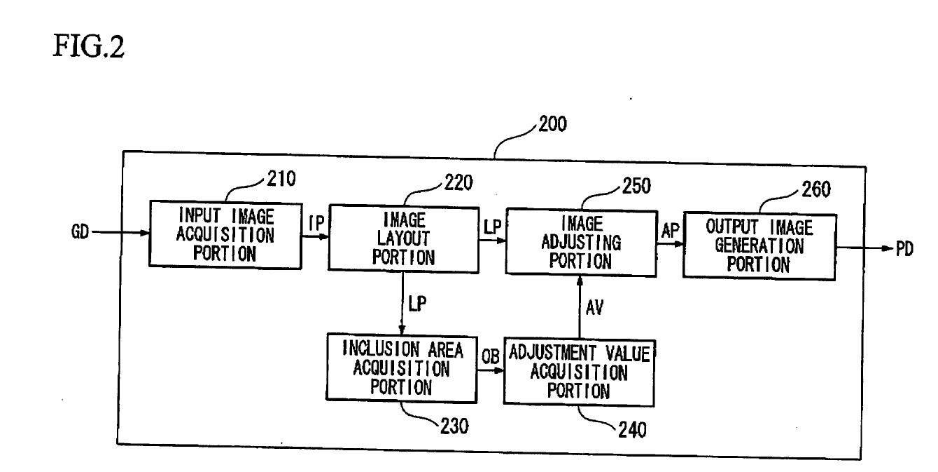

FIG. 2 is a block diagram showing the constitution of the image processing device 200 in the first embodiment.

The image processing device 200 is provided with an input image acquisition portion 210, an image layout portion 220, an inclusion area acquisition portion 230, an adjustment value acquisition portion 240, an image adjusting portion 250 and an output image generation portion 260.

The input wage acquisition portion 210 acquires a plurality of input images IP based on graphic data GD. The image layout portion 220 arranges each of the acquired input images IP (performs initial layout), and outputs initial layout image data LP. The initial layout of the images by the image layout portion 220 can be achieved by various means such as manually by the user, using templates or automatically. For example, the user can perform layout by dragging and dropping input images on the screen into the layout area (specified area) using an input device such as a mouse.

The initial layout image data LP is analyzed by the inclusion area acquisition portion 230, and an inclusion area OB that includes all the images is acquired. The adjustment value acquisition portion 240 acquires adjustment value AV based on the inclusion area OB supplied from the inclusion area acquisition portion 230 and the specified layout area set in advance. The image adjusting portion 250 outputs a final layout position AP of each image based on the initial layout image data LP supplied from the image layout portion 220 and the adjustment value AV supplied from the adjustment value acquisition portion 240.

Finally, the output image generation portion 260 generates one output image as the adjusted layout result from the plurality of input images IP and the layout position AP. Then, after image quality enhancement of the output image, output data (print data) PD is output to the printer 130.

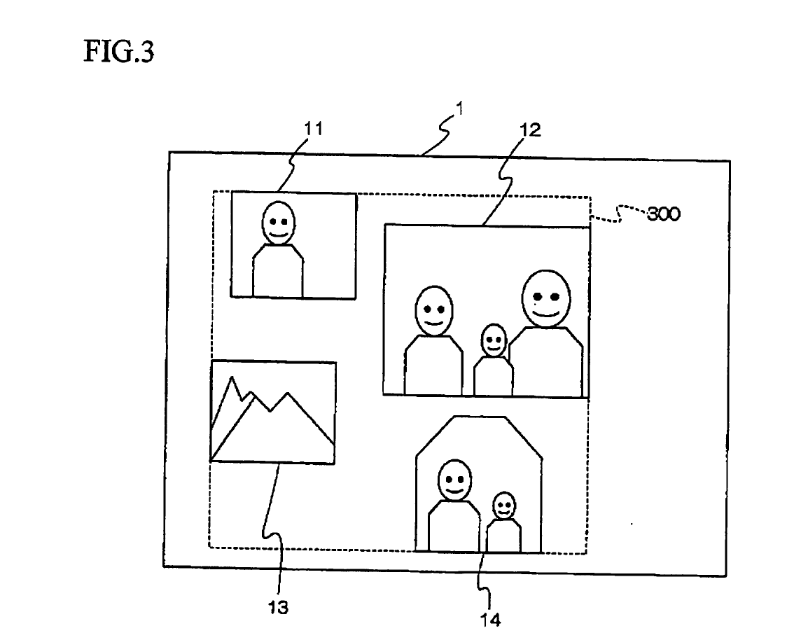

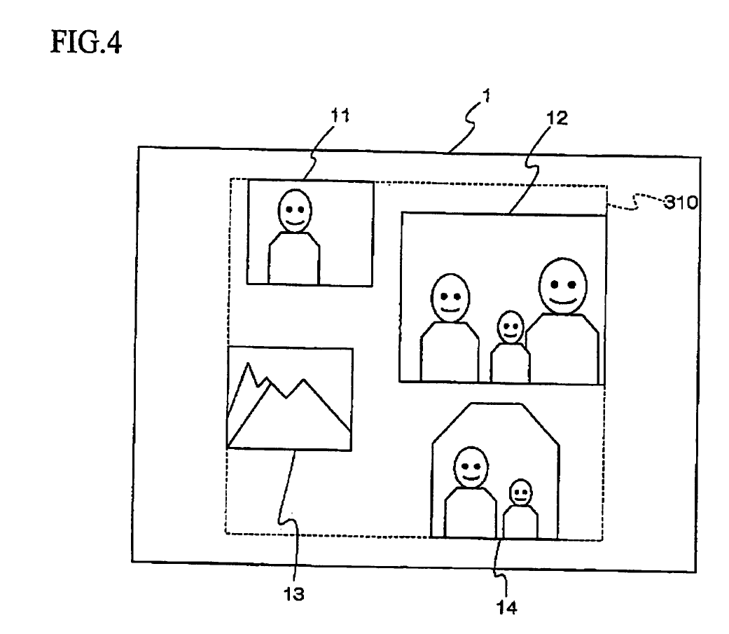

FIGS. 3 and 4 are drawings respectively showing examples of generating a placement-adjusted output image based on the initial layout image data LP. FIG. 3 shows input images 11 to 14 arranged tentatively by the image layout portion 220 in the specified layout area (specified area) 1 set in advance. Area 300 indicated by the dotted line in FIG. 3 is the inclusion area OB acquired by the inclusion area acquisition portion 230.

FIG. 4 shows the final layout result, in which the layout position has been adjusted by the output image generation portion 260. This example shows state 310 in which the inclusion area OB is set in the center of the layout area 1 by the adjustment value acquisiton portion 240.

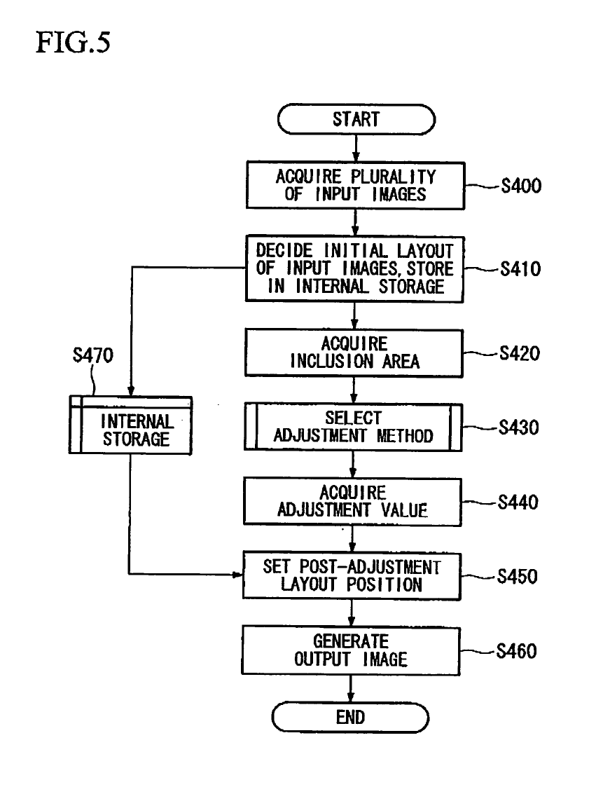

FIG. 5 is a flowchart showing the steps involved in adjusting the layout of images based on the area including the image group in the first embodiment shown in FIG. 2.

In step S400, the input image acquisition portion 210 acquires a plurality of input images based on the graphic data GD. Then in step S410, the layout positions of the images within the layout area are determined by the image layout portion 220, and the layout positions of the images are stored in internal storage (step S470). Here the layout positions may be determined by various means such as manually, by template or by automatic placement.

In step S420, the inclusion area OB including all the images is acquired by the inclusion area acquisition portion 230. The method of obtaining the inclusion area is described later. The flow then advances to step S430, where the adjustment method is selected based on user input. Possible adjustment methods include 1) arranging the inclusion area OB in the center of the layout area, 2) arranging the inclusion area OB on the left edge of the layout area, and 3) arranging the inclusion area on the right edge of the layout area, with the user making a selection each time from a selection table displayed on the screen. In the present embodiment, the adjustment method 1) that places the inclusion area OB in the center of the layout area is chosen.

In step S440, the adjustment value AV for placing the inclusion area OB in the center of the layout area is calculated by the adjustment value acquisition portion 240. The X and Y directions of the adjustment value AV are found by calculating the difference between the center of the inclusion area OB and the center of the layout area. This adjustment value AV consists of an X and Y value showing the amount by which all the images are to be moved en masse when for example based on the positional relation between the layout area and the inclusion area OB.

In step S450, the post-adjustment coordinate value (layout position) AP for each image is calculated by the image adjusting portion 250. Specifically, the coordinate value AP is calculated from the coordinates of the initial layout of the images stored in internal storage in step S470, and the adjustment value AV found in step S440.

In step S460, the output image generation portion 260 generates one output image by placing each image in the layout area in accordance with its post-adjustment coordinate value AP. After the image quality of the output image has been enhanced as required, it is output to the printer 130 as print data PD.

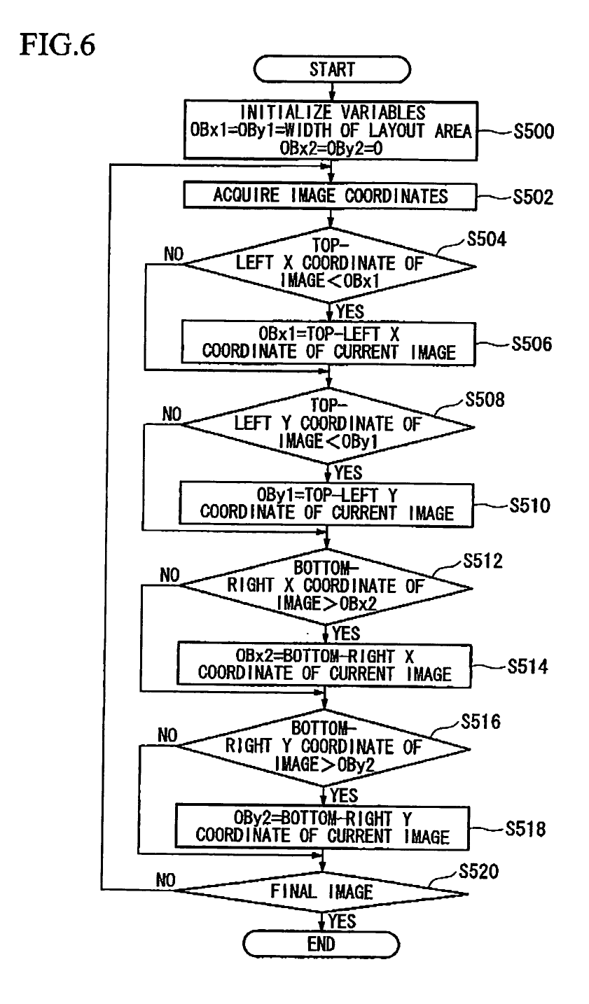

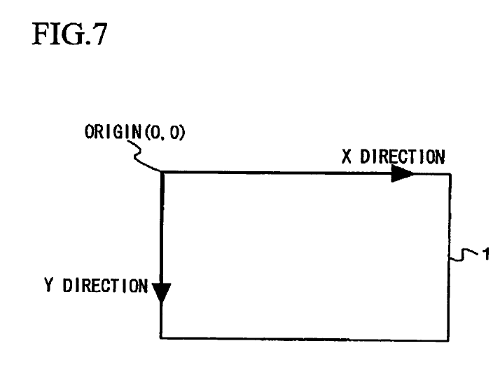

Next the processing of the inclusion area acquisition portion 230 (processing of step S420) is explained based on FIG. 6. In step S500, the variables required for obtaining the inclusion area OB are initialized. Here, in the case of taking the top-left of the layout area 1 as the basis (origin (0, 0)) for the coordinates as shown in FIG. 7, variables OBx1 and OBy1 are X, Y coordinates at the upper-left of the inclusion area OB after processing of step S420, and OBx2 and OBy2 are the X, Y coordinates at the lower-right of the inclusion area OB after processing of step S420. OBx1 and OBy1 are initialized to the width and height of the layout area to search for smaller (nearer to the origin) values, while OBx2 and OBy2 are initialized to “0” to search for larger (farther from the origin) values. OBx1 and OBy1 are not limited to the width and height of the layout area, and may be set to greater values, that is, to a range of values greater than the layout area yet still displayable in the display area.

In step S502, the first image coordinates are acquired. In step S504, the top-left X coordinate of the image is compared with OBx1, and if the top-left X coordinate of the image is smaller, then it is stored in OBx1 (step S506). If OBx1 is smaller (“NO” in step S504), the process advances to the next coordinate check step. The same process is performed for the Y direction (steps S508 and S510). Alternatively, the minimum coordinate values in the X and Y directions of the image may be set to OBx1 and OBy1, respectively.

Next, in step S512, the bottom-right X coordinate of the image is compared with OBx2, and if the bottom-right X coordinate of the image is greater, then it is stored in OBx2 (step S514). If OBx2 is greater (“NO” in step S512), the process advances to the next coordinate check step. The same process is performed for the Y direction (steps S516 and S518). Alternatively, the maximum coordinate values in the X and Y axis directions of the image may be set to OBx2 and OBy2, respectively.

In step S520, a check is made as to whether the image just processed is the last one. If any other images remain (“NO” in step S520), then the process returns to step S502 and the next image is processed.

If the image just processed is the last one (“YES” in step S520), OBx1, OBy1, OBx2 and OBy2 are output as the coordinates of the inclusion area OB and the ends.

In this way, in the first embodiment, by placing the inclusion area OB including the initial layout of the input images in the center of the layout area, the burden on the user of adjusting the image positions is lessened and an acceptable output result having good balance can be obtained having with the image group in the center of the layout area. Arrangement of the inclusion area (the images) in the layout area is not limited to the center of the layout area. For example, it can be placed in the top-left, top-right, bottom-left and bottom-right of the layout area. The area including the images can also be placed along the boundary of the layout area in the middle of each of the boundaries, or near the boundaries.

A second embodiment, which is a modification of the first embodiment, is explained below with reference to FIGS. 2, 5 and 6.

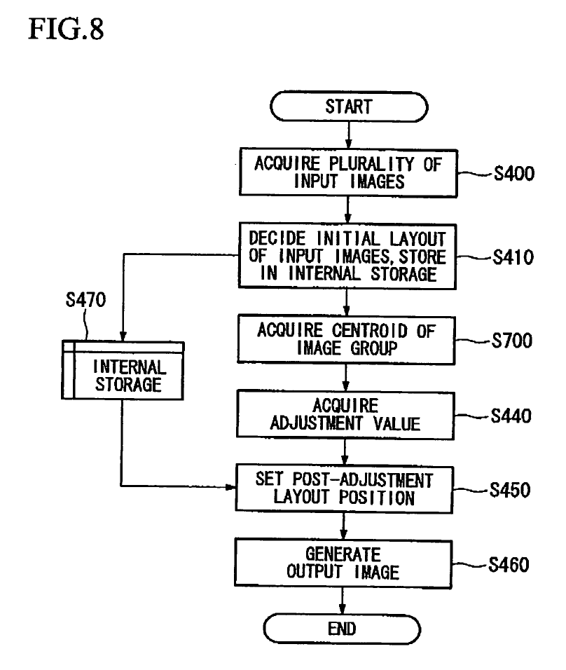

FIG. 8 is a flowchart showing the flow of adjusting the placement of images based on the centroid of the image group.

The differences with the first embodiment as shown in the drawings are as follows: the inclusion area acquisition portion 230 in FIG. 2 is replaced by a centroid acquisition portion (not shown); step S420 in FIG. 5, which acquires the inclusion area, is replaced by step S700 in FIG. 8, which acquires the centroid of the image group; and step S430 in FIG. 5, which selects the adjustment method, is deleted. The constituent features of the two embodiments are otherwise identical. In step S440 in FIG. 8, the adjustment value acquisition portion 240 calculates the adjustment value for arranging the centroid of the image group acquired by the centroid acquisition portion in the center of the layout area. The X and Y directions of the adjustment value AV are found by calculating the difference between the centroid of the image group and the center of the layout area.

Letting the centroid of the image group be COMx, COMy and the center of the layout area be CLx, CLy, the adjustment values AVx, AVy are calculated as follows:
AVx=COMx−CLx
AVy=COMy−CLy

Note that the centroid of the image group used to find the adjustment values AVx, AVy need not simply be determined based on the area of the input images IP. Instead, it may be the centroid of the image group corresponding to the image area adjusted by multiplying by a coefficient α (0<α≦1) that corresponds to the average tone of the input images IP. Doing so incorporates the weight of the appearance of the input images IP according to their tone. That is, the centroid of the image group may be made to correspond to the image area adjusted by multiplying by this coefficient α as shown below.

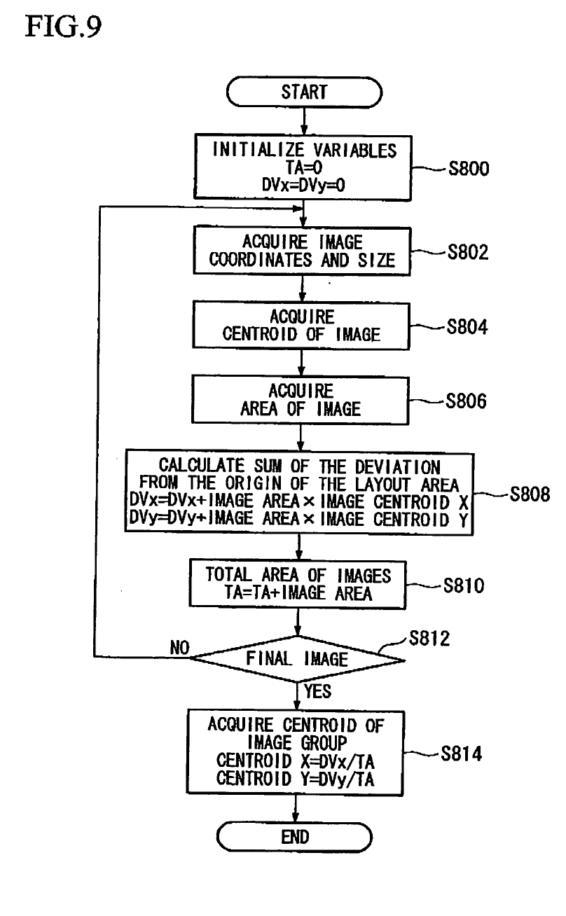

Here, a coefficient table is provided in the centroid acquisition portion linking tones to coefficient α. The area of each input image IP is weighted in accordance with the average tone value of all the pixels (the higher the weighting implying a larger apparent area or greater mass per unit area). The flowchart in FIG. 9 explains this in detail.

Below, the main differences between the first embodiment and the second embodiment are explained, focusing on the method of obtaining the centroid of the image group.

FIG. 9 shows a flowchart of the method of obtaining the centroid of an image group (process of step S700). In step S800, the variables required for obtaining the centroid is initialized. Here, the total area of the images is TA, the sum of the deviation from the origin of the layout area in the X and Y directions are DVx and DVy, respectively, and initialized to 0.

In step S802, the coordinates and size of an image are acquired. In step S804, the centroid of an image is acquired. Here, the centroid of the image is in the center of the image. Also, in step S806, the area of an image is acquired. In step S808, the sum of the deviation from the origin of the layout area (see FIG. 7) is calculated. The sum of the deviation DV=DV+image area×image centroid, and is calculated in the X and Y directions.

In other words, for each input image IP, in the X direction the product of the area of each input image IP and the X coordinate of the center of the image is added to the sum of the deviation DVx, and in the Y direction, the product of the area of each input image IP and the Y coordinate of the center of the image is added to the sum of the deviation DVy, as shown by the following equations:
DVx=DVx+image area×image center
DVy=DVy+image area×image center

Here, the image area term may not simply be the area of the input image IP. Instead, the average tone is calculated and a coefficient α (0<α≦1) corresponding to the calculated average value is drawn from a coefficient table listing average values and corresponding coefficients. This coefficient α may then be multiplied by the image area as in the equation shown below:
DVx=DVx+α×image area×image center
DVy=DVy+α×image area×image center

The coefficient α is a coefficient corresponding to the average tone of all the pixels in the input image IP, and therefore weights the image as perceived by the user according to the area of the input image IP. The centroid acquisition portion calculates the average tone of all the input images IP that have been input and compares this computed average value with the background tone. If the background tone is higher than the average tone of all the input images IP (that is, the average luminance of the images is brighter than the average luminance of the background), then the lower the average tone of all the input images IP (lower luminance), the greater the value of the coefficient α (approaching 1) is set to, and the higher the tone (higher luminance), the lower the value of the coefficient α (approaching 0) is set to.

This is because, when the background tone is higher than the average tone of all the input images IP, then the lower the tone of an input image IP, the heavier it appears.

Alternatively, when the background tone is lower than the average tone of all the input images IP (that is, the average luminance of the background is darker than the average luminance of all the images), the centroid acquisition portion sets the coefficient α to a lower value (approaching 0) the lower the average tone of all the input images IP (lower luminance) and to a higher value (approaching 1) the higher the average tone of all the input images IP (higher luminance).

This is because, when the background tone is lower than the average tone of all the input images IP, then the higher the tone of an input image IP, the lighter it appears.

The user may have the option of altering the weighting of a displayed input image IP in advance. For example, the weighing of an input image of a person can be set higher so as to be closer to the center of the layout area

When doing so, input images IP showing people that need to be emphasized are marked in advance. Then the centroid acquisition portion multiplies the coefficient α set for the tone by a prescribed ratio, for example coefficient γ (having a value such as 2, which would double the weighting of the tone) and calculates the centroid for the image group.

Next, in step S810, the total area of the images TA is calculated by adding the area of the image being processed in turn to the TA. In step S812, a check is made to determine whether the image just processed is the last image. If any other images remain (“NO” in step S812), then the process continues for the next image. If the image just processed is the last one (“YES38 in step S812), the centroid (COMX, COMy), which is the centroid position of the image group in the X and Y directions, is acquired by dividing the sum of deviation DV by the total area of the images, and the process ends.

Thus by arranging the centroid of the initially placed input image group in the center of the layout area with the second embodiment, the burden on the user of adjusting the image position in consideration of the centroid of the images is lessened, and a preferred output result having good balance can be obtained having the centroid of the image group in the center of the layout area.

According to the embodiments of the present invention, the layout of a plurality of images initially arranged can be automatically adjusted, thereby lessening the burden of the user when deciding the layout position of images.

The embodiments of the present invention can be realized by a computer and a program executed by a computer, and the program may be distributed over transmission lines or via a computer-readable recording media. The portion shown in FIG. 1 and FIG. 2 can be subdivided, integrated, or disposed by distribution over transmission lines.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An image processing device comprising:
an image layout means arranging a plurality of input images in a specified area;
an inclusion area calculation means calculating an inclusion area that includes all of the input images based on an image positions determined by the image layout means; and
an image layout adjustment means adjusting a layout of images based on the inclusion area.

2. An image processing device according to claim 1, wherein the image layout adjustment means arranges the inclusion area in a center of the specified area.

3. An image processing device according to claim 1, wherein the image layout adjustment means arranges the inclusion area so as to touch a boundary of the specified area or be near the boundary of the specified area.

4. An image processing device comprising:
an image layout means arranging a plurality of input images in a specified area;
a centroid calculation means calculating a centroid of an image group based on a image positions determined by the image layout means; and
an image layout adjustment means adjusting a layout of an image based on the centroid.

5. An image processing device according to claim 4, wherein the image layout adjustment means arranges the centroid in a center of the specified area.

6. An image processing device comprising:
an image layout means arranging a plurality of input images in a specified area;
an inclusion area calculation means calculating an inclusion area that includes all of the input images arranged by the image layout means; and
an image layout adjustment means moving each image uniformly based on a positional relation between the specified area and the inclusion area.

7. An image processing method comprising:
arranging a plurality of input images in a specified area;
calculating an inclusion area that includes all of the input images based on an image positions determined in the arranging of the input images; and
adjusting a layout of images based on the inclusion area.

8. An image processing method comprising:
arranging a plurality of input images in a specified area;
calculating a centroid of an image group based on an image positions determined in arranging of the input images; and
adjusting a layout of images based on the centroid.

9. An image processing program comprising instructions which, when executed by a computer, cause:
arranging a plurality of input images in a specified area;
calculating an inclusion area that includes all of the input images based on an image positions determined in the arranging of the input images; and
adjusting a layout of images based on the inclusion area.

10. An image processing program comprising instructions which, when executed by a computer, cause:
arranging a plurality of input images in a specified area;
calculating a centroid of an image group based on an image positions determined in the arranging of the input images; and
adjusting a layout of images based on the centroid.
